(19) United States
(12) Patent Application Publication
(10) Pub. No.: US 2026/0057504 A1
(43) Pub. Date: Feb. 26, 2026

(54) Bulk Pallet Inspection and Assembly

(71) Applicant: LuxTronic, Inc., Greenwood Village, CO (US)

(72) Inventors: James C. Evans, Englewood, CO (US); Paul S. George, Denver, CO (US); Christopher J. Piekarski, Broomfield, CO (US); Christopher Couture Del Valle, Boston, MA (US)

(21) Appl. No.: 18/812,504

(22) Filed: Aug. 22, 2024

(51) Int. Cl. G06T 7/00; B65G 15/30; G01B 21/08; G06T 7/70

(52) U.S. Cl. CPC G06T 7/0004; B65G 15/30; G01B 21/08; G06T 7/70; B65G 2201/0267; B65G 2203/042; G06T 2207/20081

(57) ABSTRACT

This disclosure provides methods, components, devices, and systems for optimizing bulk palletization of items utilizing machine learning techniques to perform automated inspection throughout the process. Some aspects, more specifically, relate to a method that supports bulk palletization of items using machine learning techniques using sensor data to perform automated inspection of a pallet assembly. Machine learning systems analyze the alignment of the items ensuring proper orientation and positioning for layering. Sensors and cameras continuously capture the items layered onto the pallet where a machine learning system can analyze the data to determine misalignments on the layer. Cameras and sensors capture the side walls of the completed pallet and machine learning systems can analyze the data to detect defects along the side walls. An analysis can be performed to determine the severity of a defect and if the severity exceeds a threshold, then corrective actions resolve the defect.

### BACKGROUND

This disclosure relates generally to palletized goods and, more specifically, to optimizing bulk palletization of items and utilizing machine learning models and techniques to perform automated inspection throughout the palletization process that can halt or divert a portion of the process and allow for remediation of detected defects.

Palletization of goods is used across a wide range of industries, including manufacturing, retail, logistics, agriculture, pharmaceuticals, and the like. Palletized goods assist modern supply chain operations, enabling businesses to manage inventory more effectively and move products through the distribution channel more efficiently. The various purposes of palletizing items include improved handling efficiency, enhanced storage optimization, increased transport efficiency, protection of goods, standardization and compliance, improved safety, streamlined loading and docking, automation, and the like.

Protection of goods, for instance, helps protect goods from damage during handling and transit. Pallets elevate products off the floor, reducing the risk of water damage, dirt, and impacts. When wrapped or secured, palletized goods are also less likely to move around or fall over, further reducing the risk of damage. Pallets are also standardized in size and shape, facilitating their use across different industries and regions. This standardization can help businesses comply with international shipping regulations and simplify the process of loading, unloading, and stacking goods in various configurations.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of item inspection during the layering of a pallet using machine learning techniques and algorithms. The method includes identifying an alignment of items organized on a conveyor belt system and aligned for placement onto a pallet using cameras positioned along the conveyor belt system. The method also includes detecting the items placed from the conveyor belt system onto the pallet, determining whether the items are placed on the layer of the pallet in accordance with a predefined requisite, and detecting whether a divider is properly placed on the layer of the pallet.

In some examples, the method further includes determining the pallet has a maximum number of layers stacked onto the pallet, measuring the height of the pallet associated with the layers on the pallet using sensors positioned around an accumulation area associated with the pallet, and inspecting sidewalls of the pallet for defects associated with the items placed along the sidewalls for each of the layers of the pallet using additional cameras positioned around a subsequent conveyor belt system. The method also includes determining if a securing mechanism is properly placed onto the pallet, wherein the securing mechanism secures the layers of the pallet to prevent the items from moving during transport.

In some examples, where the method determines the items are placed on the layer of the pallet include receiving camera data from additional cameras positioned adjacent to the pallet, inputting the camera data into a machine learning model for item positioning, and detecting, by the machine learning model, the items are improperly positioned on the pallet based on the alignment for the layer. The method also includes implementing a corrective action based on the items being improperly positioned on the pallet.

In some examples, where the method determines the items are placed on the layer of the pallet include receiving camera data from additional cameras positioned adjacent to the pallet, inputting the camera data into a machine learning model for item positioning, and detecting, by the machine learning model, the items are properly positioned on the pallet based on the alignment for the layer. The method also includes inputting the camera data into a second machine learning model for an item count of the items on the layer of the pallet, detecting, by the second machine learning model, the item count of the items is not within a predefined count associated with the layer of the pallet, and implementing a corrective action based on the item count not being within the predefined count.

One innovative aspect of the subject matter described in this disclosure can be implemented into a computing device as a system for bulk palletization accumulation and inspection of items. The system includes one or more memories that store processor-executable code, and one or more processors coupled with the one or more memories and individually or collectively configured to, in association with executing the code, cause the system to identify an alignment of items organized on a conveyor belt system and are aligned for placement onto a pallet using cameras positioned along the conveyor belt system, detect the items are placed from the conveyor belt system onto the pallet, determine the items are placed on the layer of the pallet in accordance with a predefined requisite, and detect a divider is properly placed on the layer of the pallet.

Another innovative aspect of the subject atter described in this disclosure can be implemented as a non-transitory computer-readable storage medium, including instructions stored thereon which, when executed by a processor, cause the processor to identify an alignment of items organized on a conveyor belt system and are aligned for placement onto a pallet using cameras positioned along the conveyor belt system, detect the items are placed from the conveyor belt system onto the pallet, determine the items are placed on the layer of the pallet in accordance with a predefined requisite, and detect a divider is properly placed on the layer of the pallet.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The systems, methods, and devices of this disclosure each have several innovative aspects, no single one of which is solely responsible for the desirable attributes disclosed herein.

FIG. 1 illustrates a block diagram of an exemplary automated bulk pallet inspection system, in accordance with embodiments of the present disclosure.

FIG. 2 illustrates a block diagram of an exemplary palletization environment in which the automated bulk pallet inspection system can operate, in accordance with embodiments of the present disclosure.

FIG. 3 illustrates a side view of the palletization environment with an example of cameras of the automated bulk pallet inspection system, in accordance with embodiments of the present disclosure.

FIG. 4 illustrates a side view of the palletization environment with an example of sensors of the automated bulk pallet inspection system, in accordance with embodiments of the present disclosure.

FIG. 5 illustrates a flowchart for providing automated inspection of pallet layering, in accordance with embodiments of the present disclosure.

FIG. 6 illustrates a flowchart for providing automated inspection of pallet sidewalls, in accordance with embodiments of the present disclosure.

FIG. 7 illustrates a schematic diagram of an exemplary environment in which an automated bulk pallet inspection system can operate, in accordance with embodiments of the present disclosure.

FIG. 8 illustrates a block diagram of an exemplary computing device configured to operate an automated bulk pallet inspection system, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates generally to palletized goods and, more specifically, to optimizing bulk palletization of items utilizing machine learning models and techniques to perform automated inspection throughout the palletization process. The following description is directed to some particular examples for the purpose of describing innovative aspects of this disclosure. However, a person having ordinary skill in the art will readily recognize that the teachings herein can be applied in a multitude of different ways.

### Overview

Palletization involves a process used to organize and stack goods onto pallets. Typically, conveyor belts are used to transport the goods from upstream services (e.g., production lines) directly to the pallet assembly area. Before reaching the pallet, items may pass through sorting systems that can organize them based on size, type, orientation, or destination. Once organized, the items can be placed onto the pallet, and the process can be repeated until the pallet is filled with items.

Items are oriented and positioned correctly on the conveyor to ensure they are properly aligned for stacking. This can involve the use of sensors, guides, and automated positioning systems to adjust the orientation. Once oriented and positioned, the items are grouped into layers according to the desired stacking pattern. This can involve layer formation conveyors or robotic arms that arrange the items into the correct pattern. Once a layer is formed, it can be transferred onto the pallet or formed directly on the pallet. Mechanisms such as robotic arms, layer pushers, and sliding systems can facilitate the transfer of the layer onto the pallet.

Once a layer is stacked, slip sheets, interlayer sheets, or anti-slip mats may be placed between layers to ensure stability and protect the items while on the pallet. As layers are added, the palletizing system can adjust the height to maintain an optimal working level. This is typically performed using a pallet lift or adjustable platform. Once the pallet is fully loaded, the entire stack is often secured using stretch wrapping, shrink wrapping, or strapping to prevent movement during transport. Depending on the type of item being stacked, a bottom plate may be added that can assist in the alignment and starting of the stack. An additional top plate can also be placed once the stack is completed. These plates can aid in additional securement, alignment, and containment of the stacked pallet. The finished pallet is then moved from the palletizing area to a storage or shipping area. This can be done using a conveyor system, automated guided vehicles, or forklifts.

During assembly of the bulk pallets, inspections occur to ensure that goods meet safety standards and are ready for distribution or storage. Workers can visually inspect the integrity of the pallets, which can involve examining the physical condition of the pallet itself and assessing the load stability to ensure that the items are securely stacked and will not shift during transport. The correct stacking pattern and the use of strapping or wrapping materials can also be verified during the visual inspection.

Limitations on quality control and inspection during the palletization process remain, however, as these forms of quality control and inspection are prone to error. These errors include misalignment and orientation errors, inconsistent layer formation, insufficient securing, weight distribution issues, damage to items, inspection system failures, manual inspection errors, tracking errors, and the like. For instance, human inspectors may miss defects or issues due to fatigue, distraction, or lack of training. Manual inspection is also time-consuming and may not be feasible for high-speed operations.

Various aspects of the disclosure improve existing technologies, as well as others, by providing methods, components, and systems that support bulk palletization of items. These aspects can support bulk palletization of items using machine learning techniques that utilize camera and sensor data to perform an automated inspection of the palletization process during each layer of assembly. Machine learning systems can analyze the alignment of the items to ensure that they are properly oriented and positioned for layering. Once aligned, the items can be layered. Sensors and cameras can continuously capture the items layered onto the pallet, and a machine learning system can analyze the data to determine if items are misaligned on the layer. For instance, a bottle may have fallen over during the layering process, which may need to be addressed. Additionally, sensors and cameras can capture the number of items placed on each layer to ensure the proper amount of items are placed on each layer. At any time during this process, if a defect is detected by a machine learning system, an alert can be produced that can trigger either an automated correction of the item through the use of robotic arms and the like or can involve human intervention to correct the defect.

Each layer is analyzed in the manner described above until a maximum layer is reached. Once the max layer is completed, cameras and sensors capture the side walls of the completed pallet. Machine learning systems can analyze the data to determine if defects exist along the side walls. If a defect is detected, an analysis can be performed to determine the severity of the defect, and if the severity exceeds a threshold, that would indicate that the pallet's structural integrity is compromised. If no defect is found, or if the defect does not exceed the threshold, then the pallet can be secured. Additional sensors can inspect the securing mechanism to ensure that it is properly applied and, if so, that the pallet is complete and safe for transport.

In some implementations, sensors and cameras capture the movement and trajectories of the objects that are being palletized. These movements will typically have a known and regular movement if properly placed during stacking. Embodiments of the disclosure can analyze these movements and trajectories for consistency and deviation. Boundaries and limitations on these movements can be set to allow for slight variation and maintain normal activity. If an object is detected outside of the set boundaries or limits, then a defect may have occurred. If such an event occurs, then embodiments of the disclosure may provide an alert and corrective action to remediate the defect.

Particular aspects of the subject matter described in this disclosure can be implemented to realize one or more of the following potential advantages. The present disclosure aims to provide real-time and automated inspection of a bulk palletization of items throughout the entire palletization process by implementing mechanisms that inspect each step required to palletize an item. By providing these mechanisms, improvements include reduced rework and waste, enhanced operational speed, improved inventory management, increased safety, consistency, and reliability, and faster issue resolution. For instance, aspects of the disclosure provide methods and systems that use real-time data to detect issues and defects during the palletization process that can be addressed as they are detected, resulting in the minimization of disruptions and keeping the palletization process on schedule.

### Example Automated Bulk Pallet Inspection System

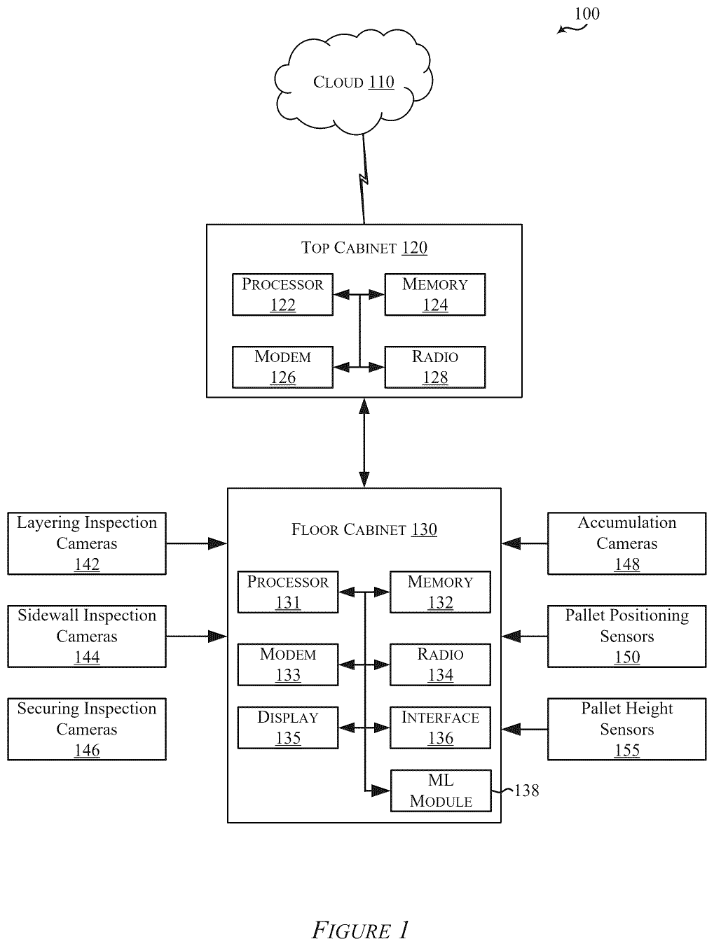

Referring now to FIG. 1, a block diagram of an example automated bulk pallet inspection system 100 suitable for use in implementing embodiments of the disclosure is shown. The bulk pallet inspection system 100 is configured to inspect items placed and positioned on a pallet during a palletization process of the items. The bulk pallet inspection system 100 can utilize sensor and camera data in conjunction with machine learning models and algorithms to inspect various stages of the palletization process. Once a pallet is assembled, the bulk pallet inspection system 100 can also utilize sensor and camera data to inspect the completed pallets for defects such as sidewall defects, height discrepancies, and securing malfunctions. The bulk pallet inspection system 100 first monitors items as they are aligned on a conveyor belt system for placement onto a layer of a pallet. Once aligned, the bulk pallet inspection system 100 can allow the aligned items to be swept onto the pallet. The bulk pallet inspection system 100 can then analyze the placed items for any defects such as misaligned, missing, or knocked-over items. If the items are properly placed on the pallet, the bulk pallet inspection system 100 can then allow for a divider to be placed on top of the layer of items and can then inspect the layer for proper alignment. Machine learning models are used during the inspection of each stage, with the model using camera and sensor data associated with the palletization process. These steps can be repeated until the pallet has a maximum number of layers stacked onto the pallet.

After the layering process is completed, the bulk pallet inspection system 100 can determine whether the maximum number of layers are stacked onto the pallet. If so, the height of the pallet can be inspected using cameras that monitor for a lower height threshold and an upper height threshold. If the pallet is within the thresholds, then the bulk pallet inspection system 100 can use camera data associated with the sidewalls of the pallet and can input that data into a machine-learning model to determine if a defect along the sidewalls exists. If such a defect exists, then an analysis can be performed to determine the severity of the defect. Corrective actions can be taken, such as human intervention or automated correction through various mechanisms, such as robotic arms, if the defect is too severe. The bulk pallet inspection system 100 can also inspect pallets that are free of defects and ready for securing. A securing mechanism can be applied to the pallet, and the bulk pallet inspection system 100 can inspect the securing mechanism to ensure that it is properly applied.

The bulk pallet inspection system 100 can be implemented as a standalone application or as part of another application or suite of applications. For example, the bulk pallet inspection system 100 can be implemented as part of a palletization application, enabling the bulk pallet inspection s to be a module of the palletization system application.

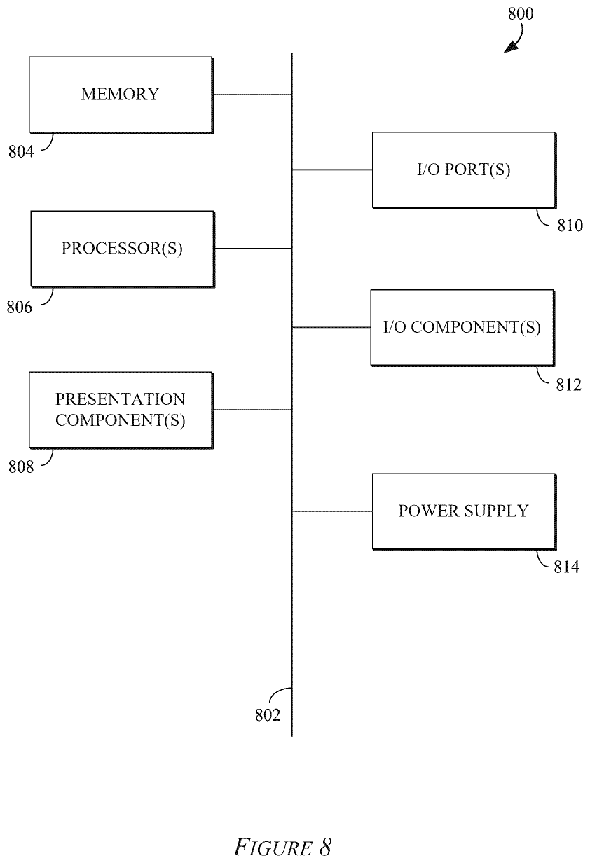

The bulk pallet inspection system 100 includes a cloud 110, a top cabinet 120, a floor cabinet, layer inspection cameras 142, sidewall inspection cameras 144, securing inspection cameras 146, accumulation cameras 148, pallet positioning sensors 150, and pallet height sensors 155. The top cabinet 120 includes a processor 122, a memory 124, a modem 126, and a radio 128. The floor cabinet 130 includes a processor, a memory 132, a modem 133, a radio 134, a display 135, an interface 136, and a machine learning module 138. The top cabinet 110 and the floor cabinet 130 may further include a computing device, such as the computing device 800 of FIG. 8.

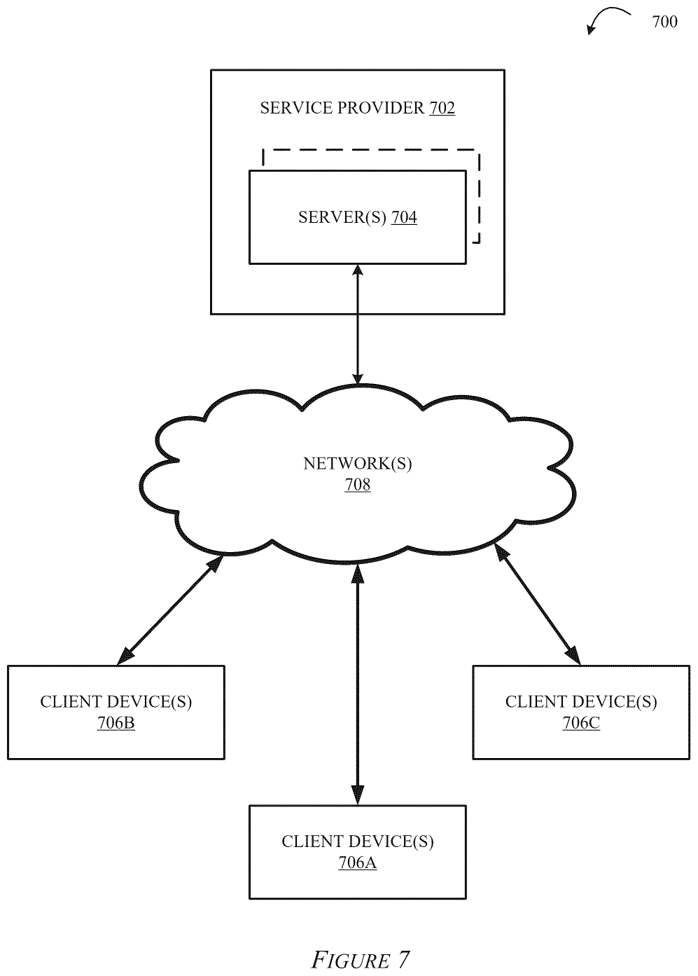

The cloud 110 is a wireless communication network of remote servers hosted on the Internet to store, manage, and process data rather than relying on local servers or personal computers. According to some aspects, the cloud 110 can be an example of a wireless local area network (WLAN), such as a Wi-Fi network. In some other examples, the cloud 110 can be an example of a cellular radio access network (RAN), such as a 5G or 6G RAN that implements one or more cellular protocols. In some examples, the cloud 110 can be embodied in a computing environment, such as the computing environment 700 of FIG. 7.

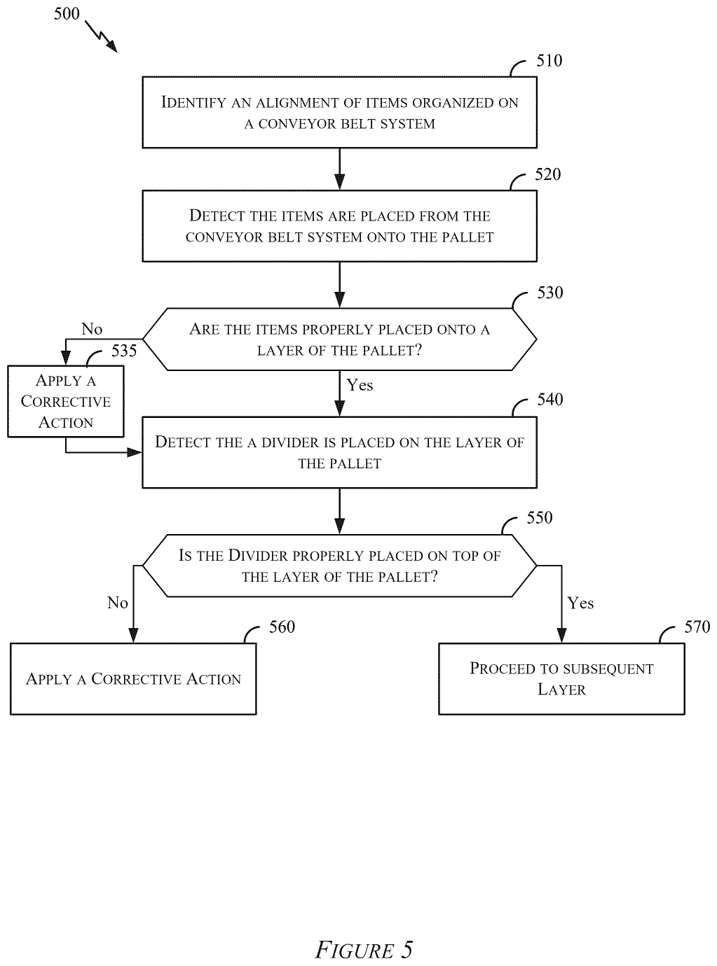

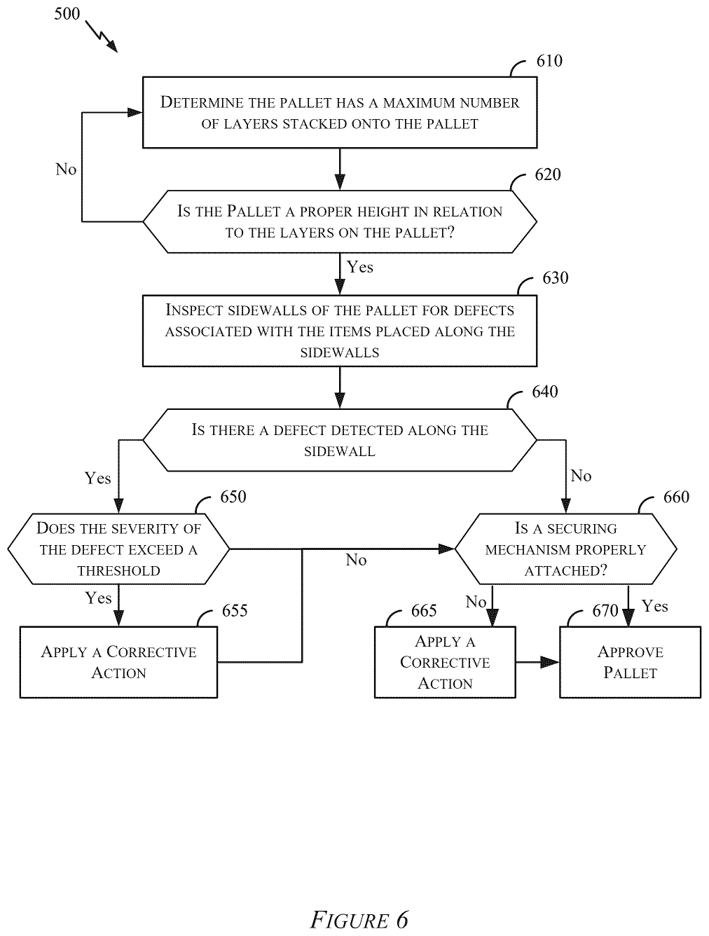

The top cabinet 110 is a component of the automated bulk pallet inspection system 100 that supports automated bulk pallet inspection. In some examples, the top cabinet 110 is configured to perform the processes 500 and 600 described with reference to FIGS. 5 and 6, respectively. The top cabinet 110 may include one or more chips, SoCs, chipsets, packages, components, or devices that individually or collectively constitute or include a processing system. The processing system may interface with other components of the top cabinet 110, and may generally process information (such as inputs or signals) received from such other components (e.g., cameras 142, 144, 146, 148, and sensors 150, 155) and output information (such as outputs or signals) to such other components.

In some examples, top cabinet 110 also includes or can be coupled with one or more application processors, which may be further coupled with one or more memories. In some examples, the top cabinet 110 further includes a user interface (UI) (such as a touchscreen or keypad) and a display, which may be integrated with the UI to form a touchscreen display that is coupled with the processing system.

The top cabinet 110 includes a processor 122, a memory 124, a modem 126, and a radio 128. Portions of one or more of the components 122, 124, 126, and 128 may be implemented at least in part in hardware or firmware. In some examples, at least some of the components 122, 124, 126, and 128 of the top cabinet 110 are implemented at least in part by a processor and as software stored in a memory. For example, portions of one or more of the modem 126 and the radio 128 can be implemented as non-transitory instructions (or “code”) executable by the processor 122 to perform the functions or operations of the respective module.

In some implementations, the processor 122 may be a component of a processing system. A processing system may generally refer to a system or series of machines or components that receives inputs and processes the inputs to produce a set of outputs (which may be passed to other systems or components of, for example, top cabinet 110). For example, a processing system of the top cabinet 110 may refer to a system including the various other components or subcomponents of the top cabinet 110, such as the processor, or a transceiver, or a communications manager, or other components or combinations of components of the top cabinet 110. The processing system of top cabinet 110 may interface with other components of the top cabinet 110 and may process information received from other components (such as inputs or signals) or output information to other components. For example, a chip or modem of top cabinet 110 may include a processing system, a first interface to output information, and a second interface to obtain information. In some implementations, the first interface may refer to an interface between the processing system of the chip or modem and a transmitter, such that top cabinet 110 may transmit information output from the chip or modem 126.

The processor 122 is capable of, configured to, or operable to process information received through the radio 128 and the modem 126, and processes information to be output through the modem 126 and the radio 128 for transmission through a wireless medium or wired medium. For example, the top cabinet 110 may process information associated with cameras and sensors and transmit the associated data to the cloud 110 and/or the floor cabinet 130. The processor 122 may perform logical and arithmetic operations using program instructions stored within the memory 124. The instructions in the memory 124 may be executable (by the processor 122, for example) to implement the methods described herein. In some examples, the processor 122, together with the memory 124, is capable of or configured to facilitate identifying an alignment of items organized on a conveyor belt system and are aligned for placement onto a pallet using cameras positioned along the conveyor belt system, detecting the items are placed from the conveyor belt system onto the pallet, determining the items are placed on the layer of the pallet in accordance with a predefined requisite, and detecting a divider is properly placed on the layer of the pallet.

The memory 124 is capable of, configured to, or operable to store and communicate instructions and data to and from the processor 122.

The modem 126 is capable of, configured to, or operable to modulate packets and to output the modulated packets over a wired medium or via the radio 128 for transmission over a wireless medium to the cloud 110. The modem 126 is similarly configured to obtain modulated packets received by the radio 128 and to demodulate the packets to provide demodulated packets.

The radio 128 includes at least one radio frequency transmitter and at least one radio frequency receiver, which may be combined into one or more transceivers. The transmitter(s) and receiver(s) may be coupled to one or more antennas. In some aspects, the processor 122, the memory 124, the modem 126, and the radio 128 may collectively facilitate the wireless communication of the top cabinet 110 with other wireless communication devices and the cloud 110. In some aspects, the processor 122, the memory 124, and the modem 126 may collectively facilitate wired communication of the top cabinet 110 with connectively attached devices over a wired connection, including the floor cabinet 130, cameras, and sensors.

The floor cabinet 130 is a component of the automated bulk pallet inspection system 100 that supports automated bulk pallet inspection and facilitates communication with the cameras 142, 144, 146, 148, and the sensors 150, 155. In some examples, the floor cabinet 130 is configured to perform the processes 500 and 600 described with reference to FIGS. 5 and 6, respectively. The floor cabinet 130 may include one or more chips, SoCs, chipsets, packages, components, or devices that individually or collectively constitute or include a processing system. The processing system may interface with other components of the floor cabinet 130, and may generally process information (such as inputs or signals) received from such other components (e.g., cameras 142, 144, 146, 148, and sensors 150, 155) and output information (such as outputs or signals) to such other components.

In some examples, floor cabinet 130 also includes or can be coupled with one or more application processors which may be further coupled with one or more other memories. In some examples, the floor cabinet 130 further includes a user interface 136 (UI) (such as a touchscreen or keypad) and a display 135, which may be integrated with the UI to form a touchscreen display that is coupled with the processing system.

The floor cabinet 130 includes a processor 131, a memory 132, a modem 133, a radio 134, a display 135, an interface 136, and a machine learning module 138. Portions of one or more of the components 131, 132, 133, 134, 135, 136, 138 may be implemented at least in part in hardware or firmware. In some examples, at least some of the components 131, 132, 133, 134, 135, 136, 138 of the floor cabinet 130 are implemented at least in part by a processor and as software stored in a memory. For example, portions of one or more of the modem 133 and the radio 134 can be implemented as non-transitory instructions (or “code”) executable by the processor 131 to perform the functions or operations of the respective module.

In some implementations, the processor 131 may be a component of a processing system. A processing system may generally refer to a system or series of machines or components that receives inputs and processes the inputs to produce a set of outputs (which may be passed to other systems or components of, for example, floor cabinet 130). For example, a processing system of the floor cabinet 130 may refer to a system including the various other components or subcomponents of the floor cabinet 130, such as the processor, or a transceiver, or a communications manager, or other components or combinations of components of the floor cabinet 130. The processing system of the floor cabinet 130 may interface with other components of the floor cabinet 130 and may process information received from other components (such as inputs or signals) or output information to other components. For example, a chip or modem of floor cabinet 130 may include a processing system, a first interface to output information, and a second interface to obtain information. In some implementations, the first interface may refer to an interface between the processing system of the chip or modem and a transmitter, such that the floor cabinet 130 may transmit information output from the chip or modem 133.

The processor 131 is capable of, configured to, or operable to process information received through the radio 134 and the modem 133, and processes information to be output through the modem 133 and the radio 134 for transmission through a wireless medium or wired medium. For example, the top cabinet 110 may process information associated with cameras and sensors and transmit the associated data to the cloud 110 and/or the floor cabinet 130. The processor 131 may perform logical and arithmetic operations using program instructions stored within the memory 132. The instructions in the memory 132 may be executable (by the processor 131, for example) to implement the methods described herein. In some examples, the processor 131, together with the memory 132, is capable of or configured to facilitate includes identifying an alignment of items organized on a conveyor belt system and are aligned for placement onto a pallet using cameras positioned along the conveyor belt system, detecting the items are placed from the conveyor belt system onto the pallet, determining the items are placed on the layer of the pallet in accordance with a predefined requisite, and detecting a divider is properly placed on the layer of the pallet.

The memory 132 is capable of, configured to, or operable to store and communicate instructions and data to and from the processor 131.

The user interface 136 may be any device that allows a user to interact with the floor cabinet 130, such as a keyboard, a mouse, a microphone, et cetera. In aspects, the user interface 136 may be integrated with the display 135 to present a touchscreen.

The modem 133 is capable of, configured to, or operable to modulate packets and to output the modulated packets over a wired medium or via the radio 134 for transmission over a wireless medium to the cloud 110. The modem 133 is similarly configured to obtain modulated packets received by the radio 134 and to demodulate the packets to provide demodulated packets.

The radio 134 includes at least one radio frequency transmitter and at least one radio frequency receiver, which may be combined into one or more transceivers. The transmitter(s) and receiver(s) may be coupled to one or more antennas. In some aspects, the processor 131, the memory 132, the modem 133, and the radio 134 may collectively facilitate the wireless communication of the floor cabinet 130 with other wireless communication devices and the cloud 110. In some aspects, the processor 131, the memory 132, and the modem 133 may collectively facilitate wired communication of the floor cabinet 130 with connectively attached devices over a wired connection, including the top cabinet 110, cameras 142, 144, 146, 148, and sensors 150, 155.

The machine learning module 138 is capable of, configured to, or operable to provide machine learning models and techniques that are trained to provide predictions associated with the automated pallet inspection system 100. Some processes, methods, operations, techniques, or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in the floor cabinet 130 to enhance various aspects associated with pallet inspection. For example, an AI/ML model may be trained to identify patterns or relationships in data observed in camera data and/or sensor data to detect aspects of the items during a palletization process. The aspects include item accumulation, orientation, and position, item proper placement while layered on a pallet, item count per layer, divider inspection, sidewall defect inspection, and securing mechanism inspection. An AI/ML model may support operational decisions relating to aspects associated with the items during the palletization process.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. For example, an AI/ML model operating on input data may start at an initial output based on the biases and then update the output based on a combination of the input data and the weights.

The top cabinet 110 and the floor cabinet 130 may receive data from the cameras 142, 144, 146, 148 and the sensors 150, 155 and may exchange data or provide feedback related to the communication. This may significantly expand the types of input data that can be considered as input to an AI/ML model, as such information may not otherwise be directly available by one cabinet.

In some examples, AI/ML models may be downloadable. For example, AI/ML model components may be shared with the floor cabinet 130 or the top cabinet 110. The floor cabinet 130 may download the AI/ML model and use the model to make decisions related to pallet inspection during a palletization process.

In some implementations, the machine learning module 138 can provide machine learning models in the form of convolutional neural networks (CNNs), region-based CNNs (R-CNNs), Recurrent Neural Networks (RNNs) and Long Short-Term Memory Networks (LSTMs), Transformers, Semantic Segmentation Models, 3D CNNs (3D-CNNs), Point Cloud Processing Models, Sensor Fusion Models, and the like. The machine learning module 138 is further operable to utilize frameworks such as TensorFlow, PyTorch, Keras, and OpenCV. Libraries such as TensorFlow Object Detection API, Detectron2, and Open3D can also be used. The models and techniques provided by the machine learning module 138 can be tailored to specific steps along the palletization process, providing varying solutions for detecting items, defects, and determining their positioning using camera and sensor data.

The layering inspection cameras 142, the sidewall inspection cameras, the securing mechanism cameras 146, and the accumulation cameras 148 are cameras configured, or operable, to capture images and camera data of items during a palletization process. The cameras 142, 144, 146, 148 can be various types of cameras. These types include, but are not limited to, RGB cameras, monochrome cameras, depth cameras, infrared (IR) cameras, thermal cameras, high-speed cameras, multispectral and hyperspectral cameras, industrial cameras, 360-degree cameras, and line scan cameras. In some implementations, a combination of these cameras may be used as the cameras 142, 144, 146, 148. For example, the sidewall inspection cameras 144 may include both RGB cameras and depth cameras.

The pallet positioning sensors 150 and the pallet height sensor 155 are sensors configured, or operable to capture sensor reading and sensor data of items and pallets during a palletization process. Sensors such as laser distance sensors (laser rangefinders), ultrasonic sensors, IR sensors, photoelectric sensors, light detection and ranging (LIDAR) sensors, proximity sensors, time-of-flight camera sensors, encoders, weight sensors, inertial measurement units, and the like can be used as the sensors 150, 155.

It is noted that FIG. 1 is intended to depict the major representative components of a bulk pallet inspection system 100. In some embodiments, however, individual components may have greater or lesser complexity than, as represented in FIG. 1, components other than or in addition to those shown in FIG. 1 may be present, and the number, type, and configuration of such components may vary.

### Example Palletization Environment

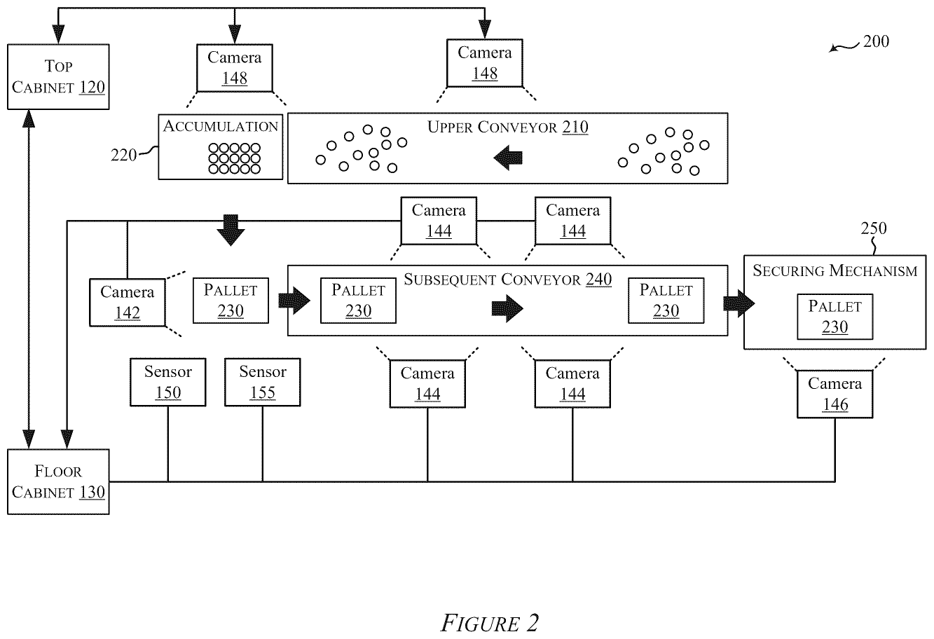

Referring now to FIG. 2, a block diagram of an example palletization environment 200 suitable for implementing embodiments of the disclosure is shown. The palletization environment 200 is an environment in which the automated pallet inspection system 100 operates. The palletization environment 200 can be part of a production line that may be any type of line such as an automated or other conveyor belt, filling line, and the like in a packaging or shipping facility. In some examples, the palletization environment 100 includes a palletizer along a conveyor belt system, such as the upper conveyor 210 and the subsequent conveyor 240. The palletizer can perform the palletization process of items including stacking items onto pallets by layers. The palletization environment 100 can integrate various palletizers such as conventional palletizers, robotic palletizers, hybrid palletizers, gantry palletizers, inline palletizers, and the like.

As shown, the top cabinet 120 and the floor cabinet 130 are control systems, power supplies, and processing units for the automated pallet inspection system 100. Items are moved via the upper conveyor 210 to the accumulation area 220. The accumulation camera 148 can monitor the accumulation process and provide camera data to the top cabinet 110 and floor cabinet 120. The accumulation cameras 148 can be positioned above the upper conveyor 210 to monitor item flow and ensure proper alignment as well as detect any issues during the alignment process.

Once items are accumulated and properly aligned, the palletizer can place the items onto the pallet 230. The layering inspection cameras 142 can be positioned adjacent (i.e., alongside, above, below, around) to the layering portion of the pallet and can capture camera data associated with the layering process. This ensures proper layering of the items and the detection of any issues during layering. The pallet 230 is continuously layered with items and lowered to the floor during the layering process. Once the pallet 230 has reached a maximum number of layers, the pallet positioning sensors 150 can detect a proper positioning of the pallet prior to allowing the pallet to traverse along the subsequent conveyor 240. The height inspection sensors 250 can also inspect the height of the pallet to ensure that the height is within a predefined height tolerance. Height inspection sensors 250 can be positioned in such a way as to scan for a lower height threshold and positioned to scan for an upper height threshold. If the pallet is below the lower height threshold, then the pallet is too short, and if the pallet height is above the upper height threshold, then the pallet is too tall.

As shown, the pallet 230 can move along the subsequent conveyor 240, and the sidewall inspection cameras 144 can capture camera data associated with the sidewalls. That camera data can be used to detect defects along the sidewalls. The subsequent conveyor 240 can move the pallet 240 to a securing mechanism 250 that applies a type of securing mechanism to the pallet such that it is ready for transport and/or storage. The securing inspection cameras 146 can be positioned adjacent (i.e., alongside, above, below, around) to the securing mechanism 250 such that they can capture the securing process to ensure a properly secure pallet.

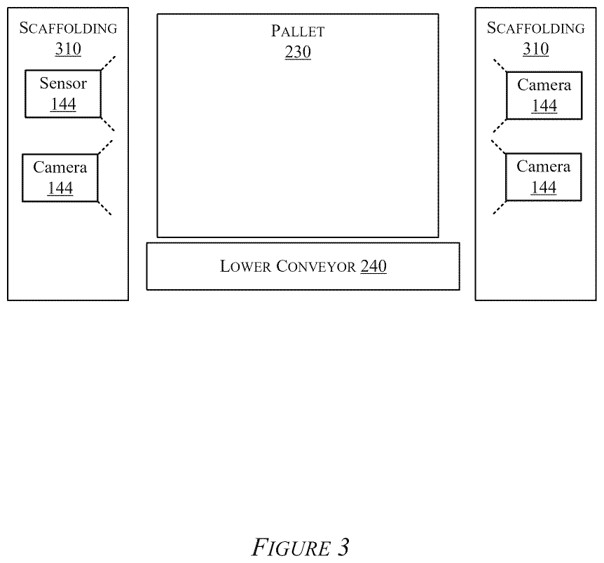

Referring now to FIG. 3, a side view of the camera placement is shown. In some implementations, along the subsequent conveyor 240 are scaffolding 310 positioned on either side of the subsequent conveyor 240. As shown, the sidewall inspection cameras 144 are placed and positioned along the scaffolding 310 to enable the cameras 144 to capture images and camera data associated with the sidewalls of a pallet as it progresses along the subsequent conveyor. It should be noted that other camera positions are possible, and the cameras 144 need only be positioned to capture images along the sidewalls of the pallet.

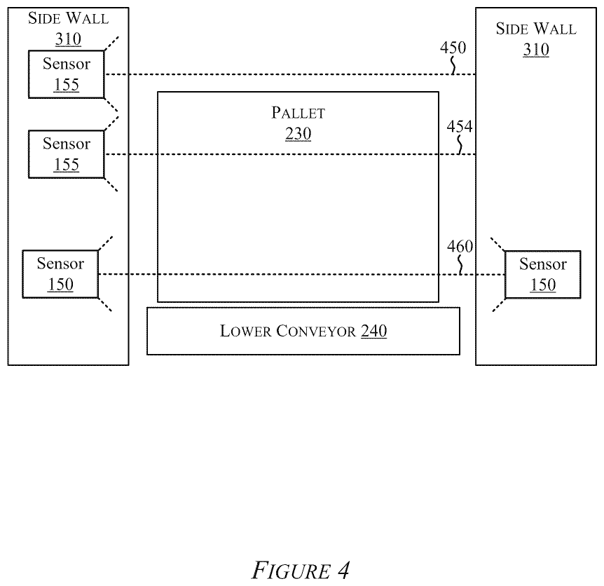

Referring now to FIG. 4, a side view of the sensor placement is shown. In some implementations, the scaffolding 310 is positioned and placed along either side of the subsequent conveyor 240. As the pallet 230 is lowered during the layering process, the pallet positioning sensors 150 and the pallet height sensors 155 can continuously monitor the position and height of the pallet. As with the camera positioning, the sensors may be placed and positioned in various orientations such that they still capture the height and positioning of the pallet.

### Example Flow Diagram

FIGS. 1-4, the corresponding text, and the examples provide a number of different systems that provide bulk palletization of items utilizing machine learning techniques to perform automated inspection throughout the process. In addition to the foregoing, embodiments can also be described in terms of flowcharts comprising acts and steps to accomplish a particular result. For example, FIG. 5 illustrates a flowchart of an exemplary method in accordance with one or more embodiments. The method described in relation to FIG. 5 may be performed with fewer or more steps/acts, or the steps/acts may be performed in differing orders. Additionally, the steps/acts described herein may be repeated or performed in parallel with one another or in parallel with different instances of the same or similar steps/acts.

With reference to FIG. 5, a flow diagram illustrating a method is provided. Each block of the method 500 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 5 shows a flowchart illustrating an example process 500 performable by or at a computing device that supports bulk palletization of items utilizing machine learning techniques to perform automated inspection throughout the process. For example, the process 500 may be performed by a computing device, such as the wireless computing device 800 described with reference to FIG. 8. In some examples, the process 400 may be performed within a computing environment such as the computing environment 700 described with reference to FIG. 7.

In some examples, the computing device is configured to perform the process 500 described with reference to FIG. 5. At block 510, the computing device identifies an alignment of items organized on a conveyor belt system. Cameras placed adjacent to an accumulation area for the items can detect the items'position and orientation. As the items accumulate, they can be arranged in a certain alignment for placement onto a layer of a pallet. If an item is not correctly oriented, an automated system, such as a robotic arm or pushers, can adjust its position to ensure proper alignment.

In some implementations, position sensors can verify the items'position on the conveyor belt and accumulation area. These sensors can ensure that each item is within the correct tolerance range before being placed onto the pallet.

In some implementations, camera data produced by the cameras positioned adjacent to the accumulation area can be used in conjunction with a machine-learning model. The machine learning model can be trained to identify a proper alignment of the items based on the type of item being placed as well as the palletization environment. Once the camera data is received, that data can be inputted into the machine learning model to determine if the items are in proper alignment for placement onto the pallet. If the model produces an output that indicates that the items are improperly placed, then the computing device prevents the items from being placed onto the pallet. Based on the alignment predicted, additional action may be needed to complete the alignment or a corrective action may be needed to make adjustments to the items to ensure that they are in proper alignment.

Once aligned, the items can be placed onto a layer of a pallet. This can occur through various mechanisms, such as robotic arms or gantry systems. Robotic arms or gantry systems can pick up the items from the accumulation area and place them onto the pallet. In some implementations, the items are swept or pushed from the accumulation area onto the pallet. These mechanisms can vary based on the item being placed.

At block 520, the computing device detects the items placed from the accumulation area or conveyor belt system and onto the pallet. Cameras positioned adjacent to the accumulation area and pallet can provide camera data that can indicate that items are no longer at the accumulation area and are not placed onto the pallet.

At block 530, the computing device determines if the items are properly placed on the layer of the pallet. In some implementations, the computing device utilizes additional cameras placed adjacent to the pallet to produce camera data associated with the item placement. The camera data can be inputted into a machine learning model trained to identify if the items are properly positioned on the pallet based on the proper alignment for the layer of the pallet. In some implementations, the camera data can also be used in a second machine-learning model trained to determine an item count of the items. If either the positioning or the count is not within a tolerance range or predefined threshold or count, then the computing device can implement a corrective action, at block 535, that prevents the palletization process from continuing and corrects the defect detected by the machine learning model.

At block 540, the computing device detects that a divider is placed on top of the layer of items on the pallet. Cameras positioned adjacent to the pallet can provide camera data that can indicate that a divider is placed on top of the layer of items.

At block 550, the computing device determines whether the layer is properly placed on top of the layer of items on the pallet. In some implementations, cameras positioned adjacent to the pallet can provide camera data that can be inputted into a machine-learning model trained to identify the proper divider positioned on top of a layer of items. If the machine learning model provides an indication that the divider is improperly placed, then the computing device can proceed to block 560 and apply a corrective action associated with the divider. The corrective action can include the use of an automated robotic arm configured to adjust the positioning of the layer based on the detected placement. In some implementations, the corrective action can include an alert to personnel, that can then manually adjust the divider. If the machine learning model indicates a proper placement of the divider, the computing device can proceed to block 570 and proceed to a subsequent layer.

With reference to FIG. 6, a flow diagram illustrating a method is provided. Each block of the method 600 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 6 shows a flowchart illustrating an example process 600 performable by or at a computing device that supports bulk palletization of items utilizing machine learning techniques to perform automated inspection throughout the process. For example, the process 600 may be performed by a computing device, such as the wireless computing device 800 described with reference to FIG. 8. In some examples, the process 600 may be performed within a computing environment such as the computing environment 700 described with reference to FIG. 7.

In some examples, the computing device is configured to perform the process 600 described with reference to FIG. 6. At block 610, the computing device determines if the pallet has reached a maximum number of layers stacked onto the pallet. The computing device can perform the steps described in process 500 repeatedly until the maximum number of layers is reached. The maximum number of layers can vary based on the items being palletized. For instance, factors such as item dimension and shape can determine how many can fit into a single layer and how many layers can be stacked without exceeding a height limit. The weight and load distribution of the item can also factor into the maximum number of layers. Heavier items generally result in fewer layers to avoid overloading the pallet and ensure the structural integrity of the item at the bottom.

Additional factors such as material and durability also contribute to the maximum number of layers a pallet can have. For instance, fragile items such as glass or electronics may require fewer layers to prevent damage from the above, while durable items can be stacked in more layers since they can withstand more pressure without damage. Once the maximum number of layers has been reached, the computing device can proceed with inspecting the fully stacked pallet.

At block 620, the computing device measures a height of the pallet associated with the layers on the pallet. In some implementations, sensors positioned around the accumulation area and pallet can be used to measure the height. The computing device can receive sensor readings from a lower sensor positioned adjacent to the pallet. The lower sensor can provide an indication as to whether the pallet height exceeds a minimum height threshold. If the pallet height exceeds the threshold, then the pallet is sufficiently tall. However, if the pallet does not exceed the threshold then the pallet is insufficiently tall. In some implementations, a second sensor reading can be used from an upper sensor positioned above the lower sensor. The upper sensor can provide an indication as to whether the pallet heigh exceeds a maximum height threshold. If the pallet height exceeds the maximum height threshold, then the pallet is too tall. However, if the pallet height does not exceed the maximum height threshold, then the pallet height is within an acceptable tolerance range. Both sensors can be used in conjunction to ensure that the pallet height is within a tolerance range before proceeding with further palletization steps.

At block 630, the computing device inspects the sidewalls of the pallet for defects. In some implementations, cameras positioned adjacent to the sidewalls of the pallet can capture camera data associated with the sidewalls. Items positioned along the sidewalls can incur various forms of defects such as crushing, bulging, tearing, shifting, scuffing and abrasions, compression damage, edge and corner damage, contamination, discoloration, punctures and holes, and the like. In some examples, the defects are directly associated with the type of item being stacked. For instance, bottles can follow over or be missing from the sidewalls during the palletization process.

At block 640, the computing device detects whether the inspection discovered that defects exist along the sidewall of the pallet. If no defect is discovered, then process 600 proceeds to block 660. However, if a defect is detected, then the process 600 proceeds to block 650. At block 650, the computing device determines whether the severity of the defect requires a corrective action.

In some implementations, the computing device implements a defect severity algorithm that can analyze the camera data of the defect. Factors such as the position of the defect, the layer of the defect, the number of items affected, and the type of item can be used to determine the severity and a determination as to whether a corrective action is needed to resolve the defect and ensure the safety and structural integrity of the pallet. If the computing device determines that the defect severity requires a corrective action, then the process 600 proceeds to block 655. However, if the computing device determines that the severity does not require a corrective action, then the process 600 process to block 660.

At block 655, the computing device applies a corrective action to resolve or mitigate the defect detected along the sidewall of the pallet. Corrective actions include, but are not limited to, implementing robotics arms that adjust or replace items along the sidewalls, implementing robotic arms to secure the defect with a securing mechanism, removing the pallet from the palletization process as the severity may be too severe for shipping, adjusting the items along the defect, and notifying personnel to inspect the defect. Once the corrective action is completed, the process 600 proceeds to block 660.

At block 660, the computing device monitors a securing mechanism applied to the pallet. Various securing mechanisms can be used to secure a pallet, including strapping (banding, stretch wrap, shrink wrap, pallet netting, pallet bands, edge protectors and corner boards, anti-slip sheets, and the like. Strapping, for instance, can include straps made of plastic or metal that can provide stability and keep the items firmly in place during transportation and storage. Strapping, as well as the other securing mechanisms, can prevent load shifting, which can lead to damage and safety hazards. If the computing device determines that a securing mechanism is properly placed, then the process proceeds to block 670 and approves the palletization process of the pallet. However, if the securing mechanism is not properly placed, the process proceeds to block 665.

At block 665, the computing device applies a corrective action to resolve the improper placement of the securing mechanism. The corrective action can include a notification to personnel to inspect the securing mechanism, a redoing of the securing mechanism, and a reapplication of the securing mechanism.

### Example Computing Environment

FIG. 7 illustrates a schematic diagram of an exemplary computing environment 700 in which the automated bulk pallet inspection system 100 can operate in accordance with one or more embodiments of the present disclosure. In one or more embodiments, the computing environment 700 includes a service provider 702, which may include one or more servers 704 connected to a plurality of client devices 706A-706C via one or more networks 708. The client devices 706A-706C, the one or more networks 708, the service provider 702, and the one or more servers 704 may communicate with each other or other components using any communication platforms and technologies suitable for transporting data and/or communication signals, including any known communication technologies, devices, media, and protocols supportive of remote data communications, examples of which will be described in more detail below with respect to FIG. 8.

Although FIG. 7 illustrates a particular arrangement of the client devices 706A-706C, the one or more networks 708, the service provider 702, and the one or more servers 704, various additional arrangements are possible. For example, the client devices 706A-706C may directly communicate with the one or more servers 704, bypassing the network 708. Or alternatively, the client devices 706A-706C may directly communicate with each other. The service provider 702 may be a public cloud service provider which owns and operates its own infrastructure in one or more data centers and provides this infrastructure to customers and end users on demand to host applications on the one or more servers 704. The servers may include one or more hardware servers (e.g., hosts), each with its own computing resources (e.g., processors, memory, disk space, networking bandwidth, etc.), which may be securely divided between multiple customers, each of which hosts their own applications on the one or more servers.

In some embodiments, the service provider may be a private cloud provider who maintains cloud infrastructure for a single organization. The one or more servers 704 may similarly include one or more hardware servers, each with its own computing resources, which are divided among applications hosted by the one or more servers for use by members of the organization or their customers.

Similarly, although the computing environment 700 of FIG. 7 is depicted as having various components, the computing environment 700 may have additional or alternative components. For example, the environment 700 can be implemented on a single computing device with the automated bulk pallet inspection system 100. In particular, the automated bulk pallet inspection system 100 may be implemented in whole or in part on the client device 706A.

As illustrated in FIG. 7, the environment 700 may include client devices 706A - 706C. The client devices 706A-706C may comprise any computing device. For example, client devices 706A-706C may comprise one or more personal computers, laptop computers, mobile devices, mobile phones, tablets, special purpose computers, or other computing devices, including computing devices described below with regard to FIG. 8. Although three client devices are shown in FIG. 7, it will be appreciated that client devices 706A-706C may comprise any number of client devices (greater or smaller than shown).

Moreover, as illustrated in FIG. 7, the client devices 706A-706C and the one or more servers 704 may communicate via one or more networks 708. The one or more networks 708 may represent a single network or a collection of networks (such as the Internet, a corporate Intranet, a virtual private network (VPN), a local area network (LAN), a wireless local network (WLAN), a cellular network, a wide area network (WAN), a metropolitan area network (MAN), or a combination of two or more such networks. Thus, the one or more networks 708 may be any suitable network over which the client devices 706A-706N may access service provider 702 and server 704, or vice versa. The one or more networks 708 will be discussed in more detail below with regard to FIG. 8.

In addition, the environment 700 may also include one or more servers 704. The one or more servers 704 may generate, store, receive, and transmit any type of data, camera data, sensor data, or other information related to pallet inspection. For example, a server 704 may receive data from a client device, such as the client device 706A, and send the data to another client device, such as the client device 702B and/or 702C. The server 704 can also transmit electronic messages between one or more users of the environment 700. In one example embodiment, the server 704 is a data server. The server 704 can also comprise a communication server or a web-hosting server. Additional details regarding the server 704 will be discussed below with respect to FIG. 8.

As mentioned, in one or more embodiments, the one or more servers 704 can include or implement at least a portion of the automated bulk pallet inspection system 100 and can comprise an application running on the one or more servers 704, or a portion of the automated bulk pallet inspection system 100 can be downloaded from the one or more servers 704. For example, the automated bulk pallet inspection system 100 can include a web hosting application that allows the client devices 706A-706C to interact with content hosted at the one or more servers 704. To illustrate, in one or more embodiments of the environment 700, one or more client devices 706A - 706C can access a webpage supported by the one or more servers 704. In particular, the client device 706A can run a web application (e.g., a web browser) to allow a user to access, view, and/or interact with a webpage or website hosted at the one or more servers 704.

Upon the client device 706A accessing a webpage or other web application hosted at the one or more servers 704, in one or more embodiments, the one or more servers 704 can provide access to sensor data, camera data or other data associated with a palletization inspection operations stored at the one or more servers 704. Moreover, the client device 706A can receive a request (i.e., via user input) to perform a bulk pallet inspection and provide the request to the one or more servers 704. Upon receiving the request, the one or more servers 704 can automatically perform the methods and processes described above. The one or more servers 704 can provide all or portions of hook load reference values and standpipe pressure reference values to the client device 706A for display to the user. The one or more servers 704 can also host a bulk pallet inspection application used for palletization purposes.

As just described, the automated bulk pallet inspection system 100 may be implemented in whole, or in part, by the individual elements 702-708 of the computing environment 700. It will be appreciated that although certain components of the automated bulk pallet inspection system 100 are described in the previous examples with regard to particular elements of the computing environment 700, various alternative implementations are possible. For instance, in one or more embodiments, the automated bulk pallet inspection system 100 is implemented on any of the client devices 706A-C. Similarly, in one or more embodiments, the automated bulk pallet inspection system 100 be implemented on the one or more servers 704. Moreover, different components and functions of automated bulk pallet inspection system 100 may be implemented separately among client devices 706A-706C, the one or more servers 704, and the network 708.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, software as a Service (“SaaS”), platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud-computing environment” is an environment in which cloud computing is employed.

### Example Operating Environment

Having described an overview of embodiments of the present technology, an example operating environment in which embodiments of the present technology may be implemented is described in order to provide a general context for various aspects of the present technology. Referring now to FIG. 8, in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should computing device 800 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 802 that directly or indirectly couples the following devices: memory 804, one or more processors 806, one or more presentation components 808, input/output ports 811, input/output components 812, and illustrative power supply 814. Bus 802 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 8 merely illustrates an example computing device that can be used in connection with one or more embodiments of the present technology. A distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 804 includes computer storage media in the form of volatile or nonvolatile memory. The memory may be removable, non-removable, or a combination thereof. Examples of hardware devices include solid-state memory, hard drives, optical-disc drives, etc. Computing device 800 includes one or more processors that read data from various entities, such as memory 804 or I/O components 812. Presentation component(s) 808 presents data indications to a user or other device. Examples of presentation components include a display device, speaker, printing component, vibrating component, etc.

I/O ports 810 allow computing device 800 to be logically coupled to other devices, including I/O components 820, some of which may be built in. Illustrative components include a microphone, joystick, game pad, satellite dish, scanner, printer, wireless device, sensors, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature”is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method of bulk palletization accumulation and inspection of items, the method comprising:
identifying an alignment of items organized on a conveyor belt system and are aligned for placement onto a pallet using cameras positioned along the conveyor belt system;
detecting the items are placed from the conveyor belt system onto the pallet;
determining the items are placed on a layer of the pallet in accordance with a predefined requisite; and
detecting a divider is properly placed on the layer of the pallet.

2. The method of claim 1, further comprising:
determining the pallet has a maximum number of layers stacked onto the pallet;
measuring a height of the pallet associated with the layers on the pallet using sensors and cameras positioned around an accumulation area associated with the pallet;
inspecting sidewalls of the pallet for defects associated with the items placed along the sidewalls for each of the layers of the pallet using additional cameras positioned around a subsequent conveyor belt system; and
determining a securing mechanism is properly placed onto the pallet wherein the securing mechanism secures the layers of the pallet to prevent the items from moving during transport.

3. The method of claim 2, wherein measuring the height of the pallet includes:
receiving a sensor reading from a lower sensor positioned adjacent to the pallet;
determining the sensor reading indicates the height of the pallet exceeds a lower height threshold;
receiving a second sensor reading from an upper sensor positioned above the lower sensor; and
determining the second sensor reading indicates the height of the pallet does not exceed an upper height threshold.

4. The method of claim 2, wherein inspecting the sidewalls includes:
receiving camera data from the cameras positioned adjacent to the pallet along the subsequent conveyor belt system;
inputting the camera data into a machine learning model for defect detection;
detecting, from the machine learning model, a defect along a sidewall of the sidewalls of the pallet;
determining a severity of the defect; and
generating an alert based on the severity of the defect along the sidewall.

5. The method of claim 2, wherein determining the securing mechanism is properly placed onto the pallet includes:
receiving camera data from the cameras positioned adjacent to the pallet along the subsequent conveyor belt system;
detecting the camera data indicates the securing mechanism is improperly placed onto the pallet; and
implementing a corrective action based on the securing mechanism being improperly placed onto the pallet.

6. The method of claim 1, wherein identifying the alignment of the items includes:
receiving camera data from the cameras positioned along the conveyor belt system;
inputting the camera data into a machine learning model for alignment detection;
determining, from the machine learning model, the items are improperly aligned for placement on the pallet;
preventing the items from be placed onto the pallet; and
allowing additional items to be accumulated along the conveyor belt system.

7. The method of claim 1, wherein determining the items are placed on the layer of the pallet includes:
receiving camera data from additional cameras positioned adjacent to the pallet;
inputting the camera data into a machine learning model for item positioning;
detecting, by the machine learning model, the items are improperly positioned on the pallet based on the alignment for the layer;
implementing a corrective action based on the items being improperly positioned on the pallet.

8. The method of claim 1, wherein determining the items are placed on the layer of the pallet includes:
receiving camera data from additional cameras positioned adjacent to the pallet;
inputting the camera data into a machine learning model for item positioning;
detecting, by the machine learning model, the items are properly positioned on the pallet based on the alignment for the layer;
inputting the camera data into a second machine learning model for an item count of the items on the layer of the pallet;
detecting, by the second machine learning model, the item count of the items is not within a predefined count associated with the layer of the pallet; and
implementing a corrective action based on the item count not being within the predefined count.

9. The method of claim 1, wherein detecting the divider is properly positioned on the layer includes:
receiving camera data from additional cameras positioned adjacent to the pallet;
inputting the camera data into a machine learning model for divider positioning;
detecting, by the machine learning model, the divider is improperly positioned on the layer of the pallet; and
implementing a corrective action based on the position of the divider.

10. A system for bulk palletization accumulation and inspection of items, the system comprising:
one or more memories that store processor-executable code; and
one or more processors coupled with the one or more memories and individually or collectively configured to, in association with executing the code, cause the system to:
identify an alignment of the items organized on a conveyor belt system and are aligned for placement onto a pallet using cameras positioned along the conveyor belt system;
detect the items are placed from the conveyor belt system onto the pallet;
determine the items are placed on a layer of the pallet in accordance with a predefined requisite; and
detect a divider is properly placed on the layer of the pallet.

11. The system of claim 10, wherein the code further causes the system to:
determine the pallet has a maximum number of layers stacked onto the pallet;
measure a height of the pallet associated with the layers on the pallet using sensors positioned around an accumulation area associated with the pallet;
inspect sidewalls of the pallet for defects associated with the items placed along the sidewalls for each of the layers of the pallet using additional cameras positioned around a subsequent conveyor belt system; and
determine a securing mechanism is properly placed onto the pallet wherein the securing mechanism secures the layers of the pallet to prevent the items from moving during transport.

12. The system of claim 11, wherein measuring the height of the pallet causes the system to:
receive a sensor reading from a lower sensor positioned adjacent to the pallet;
determine the sensor reading indicates the height of the pallet exceeds a lower height threshold;
receive a second sensor reading from an upper sensor positioned above the lower sensor; and
determine the second sensor reading indicates the height of the pallet does not exceed an upper height threshold.

13. The system of claim 11, wherein inspecting the sidewalls causes the system to:
receiving camera data from the cameras positioned adjacent to the pallet along the subsequent conveyor belt system;
inputting the camera data into a machine learning model for defect detection;
detecting, from the machine learning model, a defect along a sidewall of the sidewalls of the pallet;
determining a severity of the defect; and
generating an alert based on the severity of the defect along the sidewall.

14. The system of claim 11, wherein determining the securing mechanism is properly placed onto the pallet causes the system to:
receive camera data from the cameras positioned adjacent to the pallet along the subsequent conveyor belt system;
detect the camera data indicates the securing mechanism is improperly placed onto the pallet; and
implement a corrective action based on the securing mechanism being improperly placed onto the pallet.

15. The system of claim 10, wherein identifying the alignment of the items causes the system to:
receive camera data from the cameras positioned along the conveyor belt system;
input the camera data into a machine learning model for alignment detection;
determine, from the machine learning model, the items are improperly aligned for placement on the pallet;
prevent the items from be placed onto the pallet; and
allow additional items to be accumulated along the conveyor belt system.

16. The system of claim 10, wherein determining the items are placed on the layer of the pallet causes the system to:
receive camera data from additional cameras positioned adjacent to the pallet;
input the camera data into a machine learning model for item positioning;
detect, by the machine learning model, the items are improperly positioned on the pallet based on the alignment for the layer;
implement a corrective action based on the items being improperly positioned on the pallet.

17. The system of claim 10, wherein determining the items are placed on the layer of the pallet causes the system to:
receive camera data from additional cameras positioned adjacent to the pallet;
input the camera data into a machine learning model for item positioning;
detect, by the machine learning model, the items are properly positioned on the pallet based on the alignment for the layer;
input the camera data into a second machine learning model for an item count of the items on the layer of the pallet;
detect, by the second machine learning model, the item count of the items is not within a predefined count associated with the layer of the pallet; and
implement a corrective action based on the item count not being within the predefined count.

18. The system of claim 10, wherein detecting the divider is properly positioned on the layer causes the system to:
receive camera data from additional cameras positioned adjacent to the pallet;
input the camera data into a machine learning model for divider positioning;
detect, by the machine learning model, the divider is improperly positioned on the layer of the pallet; and
implement a corrective action based on the position of the divider.

19. A non-transitory computer readable storage medium including instructions stored thereon which, when executed by a processor, cause the processor to:
identify an alignment of items organized on a conveyor belt system and are aligned for placement onto a pallet using cameras positioned along the conveyor belt system;
detect the items are placed from the conveyor belt system onto the pallet;
determine the items are placed on the layer of a pallet in accordance with a predefined requisite; and
detect a divider is properly placed on the layer of the pallet.

20. The computer readable storage medium of claim 19, wherein the instructions further causes the processor to:
determine the pallet has a maximum number of layers stacked onto the pallet;
measure a height of the pallet associated with the layers on the pallet using sensors positioned around an accumulation area associated with the pallet;
inspect sidewalls of the pallet for defects associated with the items placed along the sidewalls for each of the layers of the pallet using additional cameras positioned around a subsequent conveyor belt system; and
determine a securing mechanism is properly placed onto the pallet wherein the securing mechanism secures the layers of the pallet to prevent the items from moving during transport.
